(19) United States
(12) Patent Application Publication
(10) Pub. No.: US 2013/0346466 A1
(43) Pub. Date: Dec. 26, 2013

(54) IDENTIFYING OUTLIERS IN A LARGE SET OF OBJECTS

(71) Applicants: Xiong Zhang, Shanghai (CN); Hung-chih Yang, Bellevue, WA (US); Danny Lange, Sammamish, WA (US)

(72) Inventors: Xiong Zhang, Shanghai (CN); Hung-chih Yang, Bellevue, WA (US); Danny Lange, Sammamish, WA (US)

(73) Assignee: MICROSOFT CORPORATION, Redmond, WA (US)

(21) Appl. No.: 13/530,140

(22) Filed: Jun. 22, 2012

(51) Int. Cl. G06F 15/16

(52) U.S. Cl. 709/201

(57) ABSTRACT

Described herein are various technologies pertaining to identifying global outlier candidates from a relatively large collection of computer-readable objects in a distributed computing environment. The collection of computer-readable objects is partitioned into a plurality of sets of objects, and local outlier candidates are identified from each set of objects in the plurality of sets of objects. The local outlier candidates are updated through a hierarchical pairwise similarity analysis until global outlier candidates are identified. Thereafter, a pairwise similarity analysis is undertaken with respect to the global outlier candidates and the sets of objects in the plurality of sets of objects to identify true global outliers.

### BACKGROUND

Computer-executed clustering is the task of employing computing devices to assign objects in a set of objects into respective groups (referred to as clusters), such that objects in the same cluster are more similar (in accordance with at least one parameter) to each other than objects in other clusters. Clustering is employed in a variety of tasks, including explorative data mining, and is a common technique for statistical data analysis used in many fields, such as machine learning, pattern recognition, image analysis, information retrieval, and bioinformatics. Various types of clustering algorithms are currently in existence to cluster various different types of objects including, but not limited to, web pages, word processing document, etc.

In many situations, however, for a given set of objects, at least one of such objects may be so dissimilar from other objects that it may desirably not be included in a cluster with any other objects. Such objects are referred to herein as outliers. If there are a relatively large number of these types of dissimilar objects, a clustering algorithm may perform sub-optimally, as the outliers are essentially noise for the clustering algorithm. Therefore, it is desirable to identify outlier objects in a set of objects prior to executing the clustering algorithm over the set of objects.

If a number of objects in the set of objects analyzed for outlier objects is relatively small, the task of identifying outlier objects in such set of outlier objects can be undertaken relatively quickly on a computing device. As the number of objects in the set of objects increases, however, the task of identifying outliers becomes non-trivial. For example, each month, several hundred million messages are generated by way of a web-based micro-blogging application. It may be desirable to execute a clustering algorithm over such messages to identify most popular topics from amongst all topics discussed in such messages. In order notation, computation time required to identify outliers in conventional outlier detection algorithms is O(n²), where n is the number of objects in the set of objects. Executing an outlier detection algorithm over a set of objects that is relative large in size, then, is non-trivial.

### SUMMARY

The following is a brief summary of subject matter that is described in greater detail herein. This summary is not intended to be limiting as to the scope of the claims.

Described herein are various technologies pertaining to identifying outlier objects in a distributed computing environment. As used herein, the term “outlier” refers to a computer-readable object in a set of computer-readable objects that is sufficiently dissimilar from every other object in the set of computer-readable objects. Similarity of two objects in a pair objects can be computed using a distance model-based computer-executable similarity algorithm that computes similarity using a defined distance threshold.

In an exemplary embodiment, objects in the set of objects can be documents. For instance, the documents may be entries generated by users of a micro-blogging application (wherein such messages are limited to some defined number of characters), web pages, text/status updates generated by way of a web-based social networking application, or the like. It is to be understood, however, that the objects can be any suitable objects that are subject to clustering including, but not limited to, images, videos, text, etc.

As noted above, the technologies described herein are particularly well-suited for execution in a distributed computing environment. Accordingly, for example, a relatively large set of objects can be partitioned into a plurality of subsets of objects, wherein the plurality of subsets are distributed amongst a respective plurality of computing nodes. A computing node that receives one of such subsets can analyze objects in such subset and identify outliers therein. Outliers in a subset of objects from the set of objects identified by respective computing nodes can be referred to herein as “local outlier candidates”. The respective computing node can identify local outlier candidates in a subset of objects by performing a pairwise similarity analysis over each possible pair of objects in the subset of objects. For example, the computing node can iteratively determine whether or not a first respective object and a second respective object in a respective pair of objects are similar to one another by executing a distance model-based algorithm over the first respective object and the second respective object. Any object in the subset of objects that is found to be similar any other object in the subset of objects is not an outlier. Based upon the pairwise similarity analysis, the computing node can output a plurality of local outlier candidates, wherein each outlier candidate has a same unique task identifier assigned thereto (wherein the task identifier is unique relative to other tasks performed at other computing nodes that are identifying local outlier candidates). Identifying local outlier candidates in a respective subset of objects can occur in parallel across multiple computing nodes in the distributed computing environment.

Therefore, it can be ascertained that the plurality of computing nodes output respective pluralities local outlier candidates. Pluralities of local outlier candidates output by at least two computing nodes can be received by another computing node in the distributed computing environment. In other words, tasks can be executed in a hierarchical manner in the distributed computing environment, such that a respective first computing node outputs a first plurality of local outlier candidates, a respective second computing node outputs a second plurality of local outlier candidates, and a respective third computing node receives the respective first plurality of local outlier candidates and the respective second plurality of local outlier candidates. The respective first plurality of local outlier candidates and the respective second plurality of local outlier candidates can be received at the respective third computing node based upon the respective task identifiers assigned to objects in the aforementioned pluralities of local outlier candidates. The unique identifier assigned to objects output by a computing node ensures such objects are not distributed amongst several other computing nodes in the distributed computing environment.

Since it is already known that objects in the respective first plurality of local outlier candidates are sufficiently dissimilar from one another, and that objects in the respective second plurality of local outlier candidates are sufficiently dissimilar from one another, the respective third computing node need only analyze pairs of local outlier candidates that include an object from the first respective plurality of objects and an object from the second respective plurality of objects. The respective third computing node can employ the distance model-based similarity algorithm mentioned above to determine whether two objects in a pair are similar to one another. Through this analysis, the third respective computing node can output an updated list of local outlier candidates (e.g., can output a respective third plurality of local outlier candidates). Again, such process can be executed in parallel by a plurality of computing nodes that are identifying local outlier candidates from different respective subsets of the original set of objects. Further, depending upon a number of objects in the original set of objects, the process of generating updated lists of local outlier candidates can occur a number of times (in a hierarchical manner).

Once a final updated list of local outlier candidates has been output by a computing node (referred to as global outlier candidates), the process can be substantially repeated to identify true global outliers from the global outlier candidates. Specifically, pairwise similarity analysis can be undertaken between the global outlier candidates and the respective subsets of objects, and the process of pair-wise analysis can be repeated until true global outliers in the set of objects are identified.

Other aspects will be appreciated upon reading and understanding the attached figures and description.

### BRIEF DESCRIPTION OF THE DRAWINGS

FIG. 1 is a functional block diagram of an exemplary system that facilitates identifying outlier objects from a set of objects.

FIG. 2 illustrates a functional block diagram of an exemplary component that facilitates identifying local outlier candidates.

FIG. 3 is a functional block diagram of an exemplary component that facilitates identifying local or global outlier candidates.

FIG. 4 illustrates an exemplary arrangement of computer-executable components in a distributed computing environment.

FIG. 5 is a flow diagram that illustrates an exemplary methodology for outputting a list of local outlier candidates.

FIG. 6 is a flow diagram that illustrates an exemplary methodology for identifying outlier candidates from a set of objects.

FIG. 7 is an exemplary computing device.

### DETAILED DESCRIPTION

Various technologies pertaining to identifying outlier objects in a relatively large set of objects will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

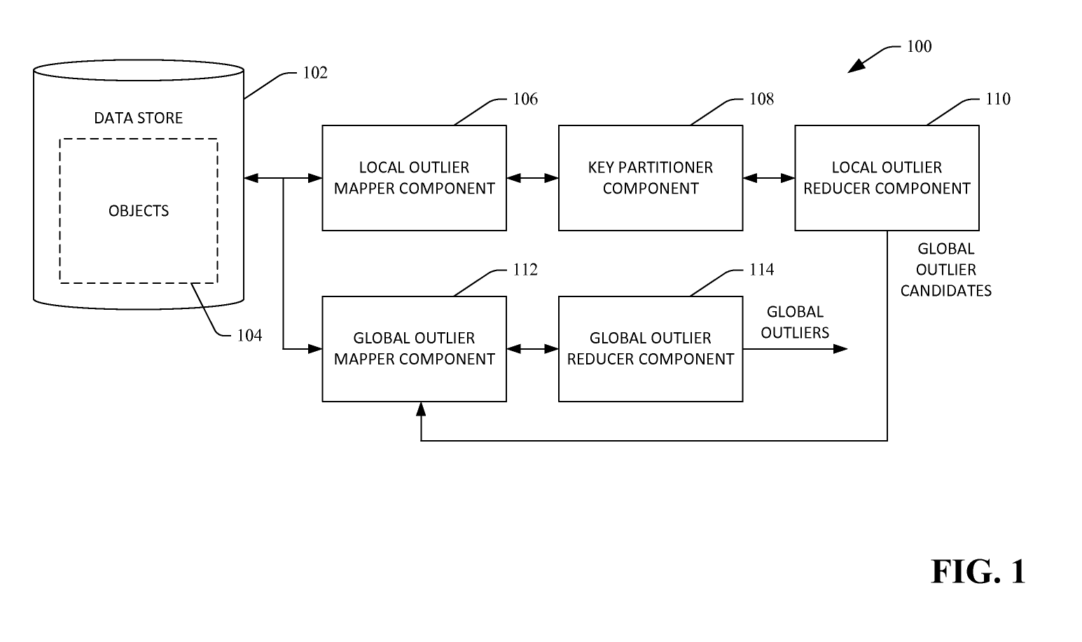

With reference now to FIG. 1, an exemplary system 100 that facilitates identifying outlier objects from amongst a set of objects is illustrated. As used herein, an outlier is an object that is found to be dissimilar from every other object in a set of objects, wherein a distance model-based approach is used to determine similarity between objects. The objects described herein are computer-readable data objects and include, but are not limited to, documents, images, videos, or the like. Further, a document can be a word-processing document, a spreadsheet, a web page, a message generated by way of a web-based micro-blogging application, text/images generated by way of a web-based social networking application, or the like. As will be shown below, determining whether a first object is sufficiently dissimilar from a second object can be undertaken through utilization of a distance model-based algorithm. For instance, each object can be represented by a respective vector (feature vector), wherein values in a feature vector are indicative of spatial position of a respective object in N-dimensional space. Using a distance model-based approach, then, a first object is similar to a second object if a computed distance therebetween is less than a defined threshold.

The system 100 is particularly well-suited for identifying outliers in a relatively large set of objects, such as a set of objects that includes several million objects. Furthermore, the system 100 is particularly well-suited for employment in a distributed computing environment that comprises a plurality of computing nodes. As used herein, a computing node may be a standalone computing device, such as a server, a personal computing device, or the like. Additionally, a computing node may be a core of a multicore processor and memory associated therewith. Still further, a computing node may be all or a portion of a system-on-chip or cluster-on-chip computing system. Moreover, a computing node may be a hardware only circuit, such as a field programmable gate array (FPGA) or other suitable circuit that is configured to perform certain functionality. The system 100 includes a plurality of components that execute particular functionality. As the system 100 can be employed in a distributed computing environment, the components described herein can be executed in parallel across multiple computing nodes. Thus, the components shown in the system 100 may be instances of respective components operating on respective computing nodes or may be executed in parallel by multiple different computing nodes.

The system 100 comprises a data store 102, which can be any suitable computer-readable data storage device. The data store 102 comprises a plurality of objects 104, wherein outliers in the plurality of objects 104 are desirably located. In an exemplary embodiment, the plurality of objects 104 may be a portion of a set of objects in which outliers are desirably identified.

The system 100 further comprises a local outlier mapper component 106 that receives the plurality of objects 104 from the data store 102. The local outlier mapper component 106 then exhaustively analyzes pairs of objects in the plurality of objects 104 to ascertain whether two objects in a pair of objects are similar to one another (through utilization of a distance model-based algorithm). Accordingly, a value that is indicative of a threshold distance between objects can be received by the local outlier mapper component 106. If two objects are found to be within the threshold distance from one another in n-dimensional space (where n is a length of a feature vector utilized to describe the objects), then the two objects are similar to one another. Through undertaking this pairwise analysis, the local outlier mapper component 106 can identify objects in the plurality of objects 104 that are dissimilar to any other object in the plurality of objects 104. In other words, the local outlier mapper component 106 can identify local outlier candidates in the plurality of objects 104. The local outlier mapper component 106 can then output the local outlier candidates.

When outputting a local outlier candidate, the local outlier mapper component 106 can assign a unique task ID to the local outlier candidate, wherein the unique task ID is assigned to each local outlier candidate output by the local outlier mapper component 106. For instance, the local outlier mapper component 106 can be a first instance of such local outlier mapper component 106 executing on a first computing node, while a second instance of the local outlier mapper component 106 is executing on a second computing node. Assigning a unique task ID to local outlier candidates output by the first instance of the local outlier mapper component 106 allows for grouping such outlier candidates and differentiating the outlier candidates from other local outlier candidates output by other instances of the local outlier mapper component 106 executing on other computing nodes.

A key partitioner component 108 can selectively distribute groups of local outlier candidates to computing nodes in the distributed computing environment based at least in part upon task identifiers assigned to respective local outlier candidates. Thus, the key partitioner component 108 ensures that local outlier candidates output by an instance of the local outlier mapper component 106 are all transmitted to a same recipient computing node (e.g., local outlier candidates output by an instance of the local outlier mapper component 106 are not distributed amongst several computing nodes). Additionally, the key partitioner component 108 receives local outlier candidates generated by other instances of the local outlier mapper component 106 executing on other computing nodes in the distributed computing environment, and selectively groups/transmits such local outlier candidates based upon respective unique task IDs assigned thereto.

The system 100 further comprises a local outlier reducer component 110 that receives a first group (list) of local outlier candidates corresponding to the set of objects 104 (e.g., output by the instance of local outlier mapper component 106 shown in FIG. 1) and a second list of local outlier candidates corresponding to another set of objects (identified by another instance of the local outlier mapper component 106 executing on another computing node). The local outlier reducer component 110 then generates pairs of local outlier candidates, wherein each pair includes a respective local outlier candidate from the first list of local outlier candidates and a respective local outlier candidate from the second list of local outlier candidates. The local outlier reducer component 110 performs an exhaustive pairwise analysis over pairs constructed in this manner and, for each pair, identifies whether a first respective local outlier candidate and a second respective local outlier candidate in a respective pair are similar (e.g., through the distance model-based algorithm). If two objects in a pair are found to be similar, then such objects are not global outliers and are not considered to be candidate local outliers. Subsequent to performing the pairwise analysis, the local outlier reducer component 110 outputs updated local outlier candidates, wherein each local outlier candidate in the updated local outlier candidates is assigned a unique task ID that corresponds to the instance of the local outlier reducer component 110 that output such local outlier candidates. While not shown, another instance of the key partitioner component 108 can receive the updated local outlier candidates and respectively distribute such outlier candidates to other computing nodes in the distributed computing environment based upon the task ID assigned thereto. In an exemplary embodiment, and as will be described below, the group of local outlier candidates output by the local outlier reducer component 110 can be analyzed in connection with another group of local outlier candidates output by another instance of the local outlier reducer component 110 executing on another computing node in the distributed computing environment. Pairwise analysis may then be undertaken again, and the process can continue until global outlier candidates are identified (e.g., candidate outliers for an entire set of objects that includes the plurality of objects 104). The utilization of a hierarchical arrangement of instances of local outlier reducer components mitigates a computing bottleneck that can occur when identifying global outlier candidates from a relatively large set of objects.

As noted, a result of the interaction between the local outlier mapper component 106 and the local outlier reducer component 110 (and other instances of the local outlier reducer component 110 executing on other computing nodes in the distributed computing environment) is the identification of a set of global outlier candidates. Such global outlier candidates are objects that have been found to be sufficiently dissimilar from every other object to which such objects have been paired within the relatively large set of objects. It can be ascertained, however, that it is possible that at least one global outlier candidate may not be a true global outlier, as such global outlier candidate has not been analyzed with respect to each object in a relatively large set of objects (e.g., some objects were discarded as being potential outliers by the local outlier mapper component 106 and/or the local outlier reducer component 110 when considering a subset of the relatively large set of objects).

Accordingly, the system 100 can include a global outlier mapper component 112 that receives the global outlier candidates output by the local outlier reducer component 110. Further, the global outlier mapper component 112 can receive the plurality of objects 104 from the data store 102. The global outlier mapper component 112 performs a pairwise analysis over objects in the global outlier candidates and the plurality of objects 104, respectively. In other words, the global outlier mapper component 112 performs the distance model-based similarity analysis over each object in the global outlier candidates with respect to each object in the plurality of objects 104 to ensure that the global outlier candidates are, in fact, true global outliers. As with other components in the system 100, differing instances of the global outlier mapper component 112 can be executing on different computing nodes in parallel.

The global outlier mapper component 112 outputs updated global outlier candidates, wherein each global outlier candidate output by the global outlier mapper component 112 has a unique task ID corresponding to the instance of the global outlier mapper component 112 assigned thereto. The key partitioner component 108, while not shown, then causes the updated global outlier candidates output by the global outlier mapper component 112 to be transmitted to a same computing node for further analysis.

The system 100 further comprises a global outlier reducer component 114 that receives a resultant list of updated global outlier candidates from the global outlier mapper component 112. The global outlier reducer component 114 further receives a list of global outlier candidates from another instance of the global outlier mapper component 112 executing on another computing node in the distributed computing environment, and again performs a pairwise analysis over global outlier candidates in the respective lists. The aforementioned process can iterate until global outliers are identified, wherein the global outlier reducer component 114 can output updated global outlier candidates with a unique task ID assigned thereto.

In an exemplary embodiment, the system 100 can be employed in connection with a distributed computing framework, such as the map-reduce framework, although aspects described herein are not intended to be limited to such framework. The map-reduce framework supports map operations and reduce operations. Generally, a map operation refers to a master computing node receiving input, dividing such input into smaller sub-problems, and distributing such sub-problems to worker computing nodes. A worker node may undertake the task set forth by the master node and/or can further partition and distribute the received sub-problem to other worker nodes as several smaller sub-problems. In a reduce operation, the master node collects output of the worker nodes (answers to all the sub-problems generated by the worker nodes) and combines such data to form a desired output. The map and reduce operations can be distributed across multiple computing nodes and undertaken in parallel so long as the operations are independent of other operations. As data in the map reduce framework is distributed between computing nodes, key/value pairs are employed to identify corresponding portions of data.

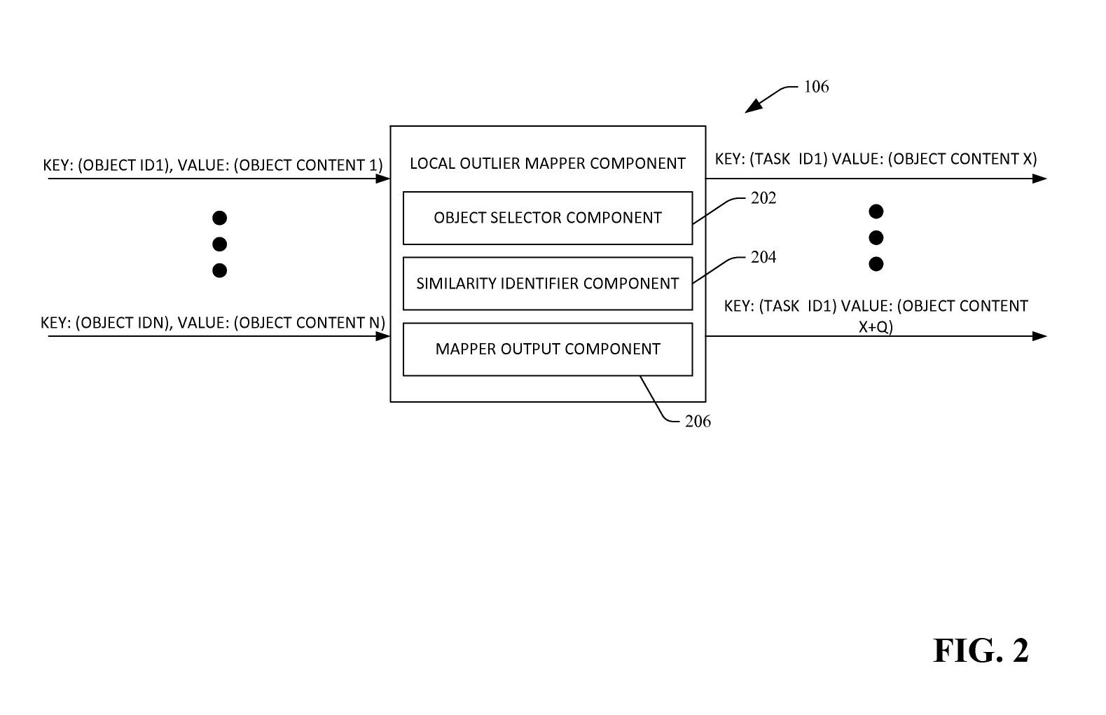

With reference now to FIG. 2, an exemplary depiction of the local outlier mapper component 106 is illustrated. As mentioned above, the local outlier mapper component 106 can refer to a map operation that is undertaken in a distributed computing environment in accordance with the map-reduce framework. Therefore, the local outlier mapper component 106 can receive and output data in the form of key/value pairs. As shown, the local outlier mapper component 106 can receive a plurality of key/value pairs, wherein a key of a respective key/value pair is an object identifier, and a value of the respective key/value pair is corresponding object content. In an exemplary embodiment, the value of the respective key/value pair can be a feature vector that is descriptive of content of the corresponding object. Alternatively, such feature vector can be computed at the local outlier mapper component 106 responsive to receiving object content (e.g., text of a document).

The local outlier mapper component 106 comprises an object selector component 202 that generates pairs of objects from amongst the received objects. The object selector component 202 can select an object from the objects that are received by the local outlier mapper component 106 and can compare such object with every other object in the objects received by the local outlier mapper component 106. For example, the object selector component 202 can select a first object and can pair such object with a second object.

The local outlier mapper component 106 comprises a similarity identifier component 204 that performs a similarity analysis over objects in an object pair created by the object selector component 202. For example, the similarity identifier component 204 determines whether the first object and the second object are similar to one another. If the first object and second object are found to be similar by the similarity identifier component 204, neither the first object nor the second object can be a local outlier candidate. The object selector component 202 then selects the first object and pairs the first object with a third object, and the similarity identifier component 204 determines whether the first object is similar to the third object. This process continues until the first object has been compared with every other object received by the local outlier mapper component 106. Thereafter, the object selector component 202 selects the second object and creates pairs of objects that include the second object (except for a pair including the first object since that has already been analyzed). The similarity identifier component 204 performs a similarity analysis over each pair.

With more particularity, the similarity identifier component 204 can use a distance model-based algorithm to identify whether two objects are similar. For instance, given an input data set S={x₁, . . . , x_{N}}, if xεS is an outlier with respect to similarity threshold t>0, then similarity(x,y)≦t,∀yεS (or distance(x,y)>1−t,∀yεS), where y represents objects other than x in the input data set. In an exemplary embodiment, a determination as to whether a first object is similar to a second object can be undertaken by the local outlier mapper component 106 through computing a partial similarity, which can be based upon the Dice coefficient or the Jaccard coefficient. Pursuant to an example, the Dice coefficient defines similarity as follows:

$$similarity ( x , y ) = \frac{2 \vert x ⋂ y \vert}{\vert x \vert + \vert y \vert} \leq \frac{2 \times min ( \vert x \vert , \vert y \vert )}{\vert x \vert + \vert y \vert}$$

where x=(x₁, . . . x_{D})^{T}, y=(y₁, . . . , y_{D})^{T}, |·| is the number of non-zero (or non-empty) components of a vector, and

x∩y=(δ(x₁,y₁), . . . (x_{D},y_{D}))^{T}

where

$$δ ( {x}_{1} , {y}_{1} ) = \{ \begin{matrix}{x}_{i} if {x}_{i} = {y}_{i} and {x}_{i} \neq 0 \\ 0 , otherwise ,\end{matrix}$$

i=1, . . . , D. Accordingly, the similarity identifier component 204 can ascertain whether a first object is sufficiently dissimilar from a second object through utilization of the following algorithms:

min(|x|,|y|)≦0.5×t×(|x|+|y|), (meaning x and y are sufficiently dissimilar);

Σₜ₌₁^{k}δ(xᵢ,yᵢ)>0.5×t×(|x|+|y|), k=1, . . . , D, where

$$δ ( {x}_{i} , {y}_{i} ) = \{ \begin{matrix}1 , if {x}_{i} = {y}_{i} and {x}_{i} \neq 0 \\ 0 , otherwise ,\end{matrix}$$

meaning that x and y are identified as being similar to one another.

For purposes of explanation, exemplary pseudocode corresponding to the similarity identifier component 204 is set forth below:

Function isNotOutlier(x, y, t)

Begin

Set m = min(cardinality(x), cardinality(y))
Set r = 0.5*t*(cardinality(x)+cardinality(y))
If m ≦ r

Return false

End if
Set m = 0
For i = 1 to D

If x[i] is equal to y[i]

Set m = m + 1
If m > r

Return true

End if

End if

End for
Return false

End

The local outlier mapper component 106 further comprises a mapper output component 206 that outputs a respective key/value pair for each object in the objects received by the local outlier mapper component 106 that is found to be sufficiently dissimilar (by the similarity identifier component 204) to every other object received by the local outlier mapper component 106. Furthermore, a key of the respective key/value pair includes a unique task ID (which is assigned to the instance of the local outlier mapper component 106 outputting local outlier candidates). Accordingly, in an exemplary embodiment, the key/value pair corresponding to a local outlier candidate identified by the local outlier mapper component 106 can have a form as follows: key: (Task ID), value: (object content). Thus, it can be ascertained that each respective key/value pair includes the unique task ID as a portion of a respective key. As alluded to above, including the unique task ID in each local outlier candidate output by the local outlier mapper component 106 allows for local outlier candidates output by respective instances of the local outlier mapper component 106 to be grouped when transmitted to other computing nodes in the distributed computing environment. For instance, the key partitioner component 108 can cause local outlier candidates to be transmitted such that each instance of the local outlier reducer component 110 in the distributed computing environment receives groups of local outlier candidates identified by two instances of the local outlier mapper component 106.

Exemplary pseudocode for the local outlier mapper component 106 is set forth below for purposes of explanation:

| | |
|---|---|
| 1: | class Outlier Candidate Mapper |

| | |
|---|---|
| 2: | List outlierCandidates |
| 3: | method setup( ) |

| | |
|---|---|
| 4: | load t from configuration |

| | |
|---|---|
| 5: | method map(sample y) |

| | |
|---|---|
| 6: | set isCandidate = true |
| 6: | for each x in outlierCandidates |

| | |
|---|---|
| 7: | if isNotOutlier(x, y, t) |

| | |
|---|---|
| 8: | remove x from outlierCandidates |
| 9: | set isCandidates = false |
| 10: | break |

| | |
|---|---|
| 11: | if isCandidates = true |

| | |
|---|---|
| 12: | add y to outlierCandidates |

| | |
|---|---|
| 13: | method cleanup( ) |

| | |
|---|---|
| 14: | for each x in outlierCandidates |

| | |
|---|---|
| 15: | emit(task id, x) |

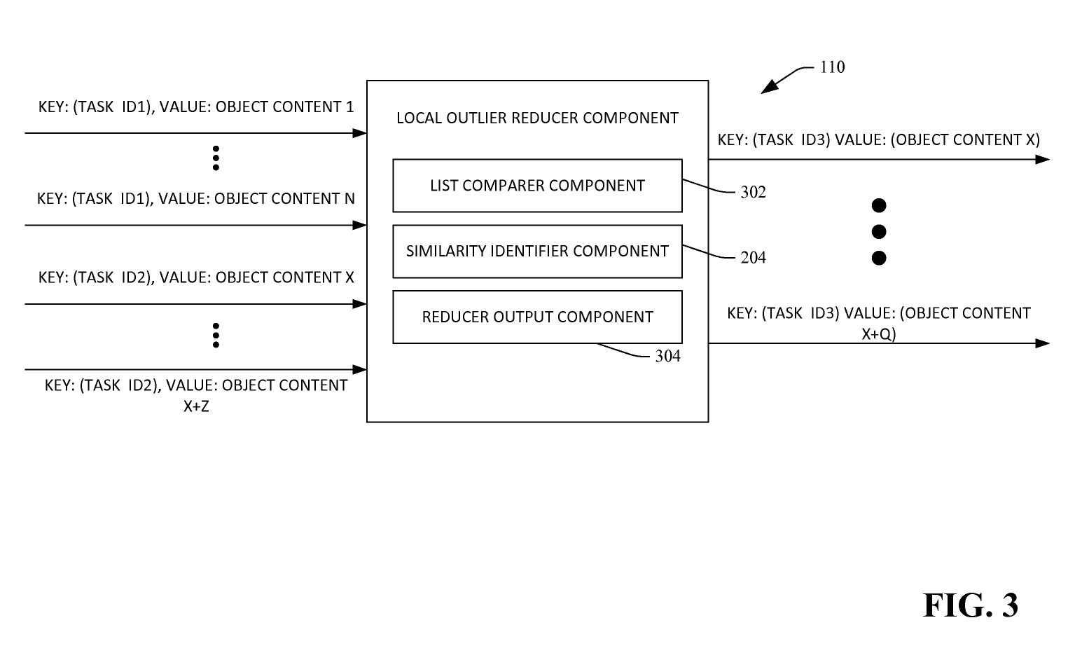

Now referring to FIG. 3, an exemplary depiction of the local outlier reducer component 110 is shown. The local outlier reducer component 110 receives two groups of local outlier candidates from two (or more) respective instances of the local outlier mapper component 106 or two (or more) respective instances of the local outlier reducer component 110. More specifically, the local outlier reducer component 110 can receive two groups of key/value pairs corresponding to two respective unique task IDs. For instance, a first group of key/value pairs can include key/value pairs that each have a first task ID included in a respective key, and a second group of key/value pairs can include key/value pairs that each have a second task ID included in a respective key.

The local outlier reducer component 110 comprises a list comparer component 302 that generates pairs of local outlier candidates from the received groups of local outlier candidates, wherein each pair generated by the list comparer component 302 includes a local outlier candidate from the first group of local outlier candidates and a local outlier candidate from the second group of local outlier candidates. For each pair of local candidate outlier objects, the similarity identifier component 204 ascertains if the objects included in a respective pair are similar. If the objects in a pair are found to be similar, then such objects are not global outliers in the relatively large set of objects, and are removed as being outlier candidates.

The local outlier reducer component 110 further comprises a reducer output component 304 that outputs an updated group of local outlier candidates. For instance, for each local outlier candidate in the first group of local candidate outliers that is found to be dissimilar to each local outlier candidate in the second group of local outlier candidates, the reducer output component 304 can output a key/value pair that indicates that the respective local outlier candidate from the first group of local outlier candidates remains a global outlier candidate. The reducer output component 304 can output data in the form of a key/value pair, wherein a key of the key/value pair includes a unique task ID corresponding to the instance of the local outlier reducer component 110, and the value of the key/value pair includes content of the global outlier candidate.

For purposes of explanation, exemplary pseudocode corresponding to the local outlier reducer component 110 is set forth below:

| | |
|---|---|
| 1: | class Outlier Candidate Reducer |

| | |
|---|---|
| 2: | List outlierCandidates1 |
| 3: | int taskId = −1 |
| 4: | method reduce(int key, List samples) |

| | |
|---|---|
| 5: | if taskId < 0 |

| | |
|---|---|
| 6: | set taskId = key |
| 7: | for each x in samples |

| | |
|---|---|
| 8: | add x to outlierCandidates |

| | |
|---|---|
| 9: | else |

| | |
|---|---|
| 10: | create List outlierCandidates2 |
| 11: | for each y in samples |

| | |
|---|---|
| 12: | set isCandidate = true |
| 13: | for each x in outlierCandidates1 |

| | |
|---|---|
| 14: | if isNotOutlier(x, y, t) |

| | |
|---|---|
| 15: | remove x from outlierCandidates |
| 16: | set isCandidate = false |
| 17: | break |

| | |
|---|---|
| 18: | if isCandate = true |

| | |
|---|---|
| 19: | add y to outlierCandidates2 |

| | |
|---|---|
| 20: | append outlierCandidates2 to outlierCandidates |

| | |
|---|---|
| 21: | method cleanup( ) |

| | |
|---|---|
| 22: | for each x in outlierCandidates |

| | |
|---|---|
| 23: | emit(task id, x) |

As noted above, an instance of the local outlier reducer component 110 can output global outlier candidates, which can be provided to an instance of the global outlier mapper component 112. The global outlier mapper component 112 operates in a manner that is similar to the local outlier mapper component 106. Exemplary pseudocode that pertaining to the global outlier mapper component 112 is set forth below:

| | |
|---|---|
| 1: | class Outlier Mapper |

| | |
|---|---|
| 2: | List outlierCandidates |
| 3: | method setup( ) |

| | |
|---|---|
| 4: | load t from configuration |
| 5: | load outlier candidates and store them into |
| | outlierCandidates list |

| | |
|---|---|
| 6: | method map(sample y) |

| | |
|---|---|
| 7: | for each x in outlierCandidates |

| | |
|---|---|
| 8: | if x != y and isNotOutlier(x, y, t) |

| | |
|---|---|
| 9: | remove x from outlierCandidates |
| 10: | emit (index of x in the list, (−1, x)) |

| | |
|---|---|
| 11: | method cleanup( ) |

| | |
|---|---|
| 12: | for each x in outlierCandidates |

| | |
|---|---|
| 13: | emit(index of x in the list, (mapper id, x)) |

Additionally, exemplary pseudocode pertaining to the global outlier reducer component 114 is set forth below:

| | |
|---|---|
| 1: | class Outlier Reducer |

| | |
|---|---|
| 2: | method reduce(int key, List of (mapper id, x)) |

| | |
|---|---|
| 3: | set isOutlier = true |
| 4: | for each (mapper id, x) in the list |

| | |
|---|---|
| 5: | if mapper id < 0 |

| | |
|---|---|
| 6: | set isOutlier = false |
| 7: | break |

| | |
|---|---|
| 8: | if isOutlier |

| | |
|---|---|
| 9: | emit x |

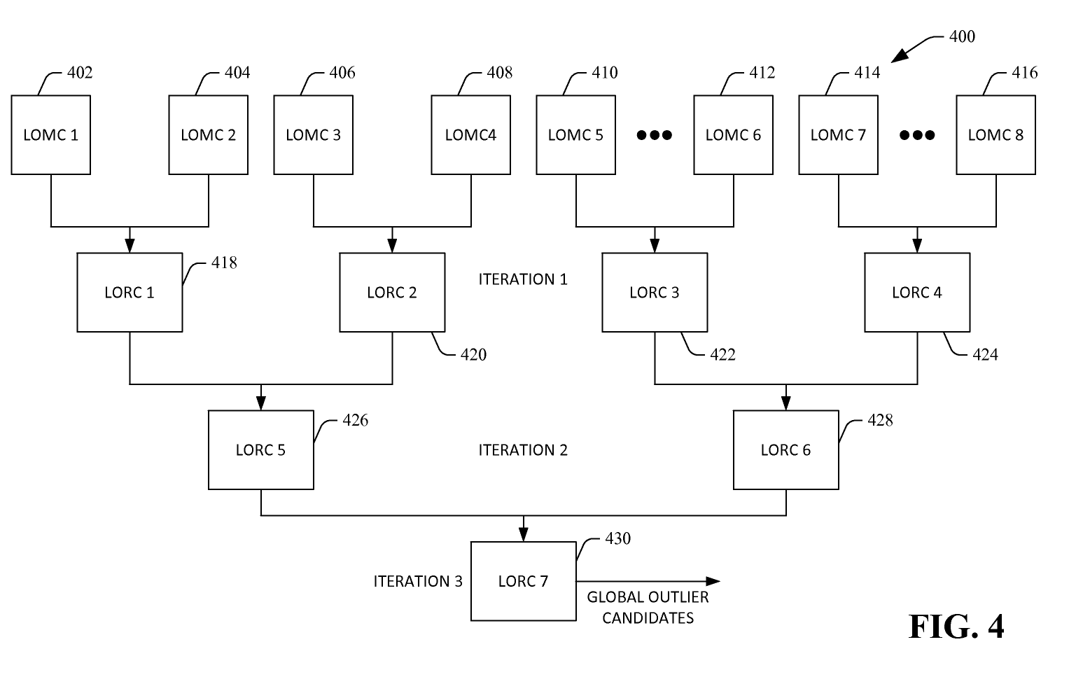

With reference now to FIG. 4, an exemplary arrangement 400 of instances of local outlier mapper components and local outlier reducer components in a distributed computing environment is illustrated. When initializing the system 400, a number of desired instances of local outlier reducer components that are to be executed can be defined. In an exemplary embodiment, a number of instances of the local outlier reducer component 110 can be set as a factor of 2, where k=0, 1, . . . , K such that 2^{K} is approximately one half of a number of instances of the local outlier mapper component 106 included in the system 400. In the exemplary system 400, there are shown to be eight instances 402-416 of the local outlier mapper component 106. Accordingly, in this exemplary system 400, a number of instances of the local outlier reducer component 110 that are to receive local outlier candidates from the instances 402-416 of the local outlier mapper component 106 can be set to four. Therefore, in the exemplary system 400, four instances 418-424 of the local outlier reducer component 110 receive local outlier candidates from eight instances 402-416 of the local outlier mapper component 106, with each instance of the local outlier reducer component 110 receiving local outlier candidates from two instances of the local outlier mapper component 106.

As described above, each instance of the local outlier mapper component 106 generates a respective task identifier that is unique to a respective instance of the local outlier mapper component 106, and assigns the respective task identifier to each local outlier candidate output thereby. Therefore, the first instance 402 of the local outlier mapper component 106, in association with each local outlier candidate identified thereby, emits a first task ID, while the second instance 404 of the local outlier mapper component 106, for each local outlier candidate identified thereby, emits a second task ID. Dedicated key partitioner components (not shown) are employed to ensure that each of the instances 418-424 of the local outlier reducer component 110 receives data emitted by two respective instances of the local outlier mapper component 106 (and only two instances). The instances 418-424 of the local outlier reducer component 110, responsive to receiving two respective groups of local outlier candidates, computes pairwise similarity values for local outlier candidates being assigned different task IDs, identifies updated local outlier candidates, and emits respective updated outlier candidates with a task ID corresponding to the respective instance of the local outlier reducer component 110.

If the number of instances of the local outlier reducer component in an iteration is equal to 1, then it can be ascertained that global outlier candidates have been found. Otherwise, the number of instances of the local outlier reducer component is divided by two and the process continues. That is, for instance, with respect to the first instance 418 of the local outlier reducer component 106 and the second instance 420 of the local outlier reducer component 106, such instances 418 and 420 output respective groups of local outlier candidates with respective unique task IDs assigned thereto. A dedicated key partitioner ensures that a fifth instance 426 of the local outlier reducer component 106 receives each local outlier candidate identified by the instance 418 of the local outlier reducer component 106 and each local outlier candidate identified by the instance 420 of the local outlier reducer component 106. Likewise, a sixth instance 428 of the local outlier reducer component 110 receives groups of local outlier candidates from the third instance 422 of the local outlier reducer component 110 and the fourth instance 424 of the local outlier reducer component 110, performs a pairwise similarity analysis over objects in the respective groups, and outputs updated local outlier candidates with a unique task ID assigned thereto.

A seventh instance 430 of the local outlier reducer component 110 receives local outlier candidates from the fifth and sixth instances 426 and 428 of the local outlier reducer component 110, respectively, performs the pairwise similarity analysis over local outlier candidates in the groups, and outputs global outlier candidates. As discussed above, the global outlier candidates are further analyzed with respect to the original sets of objects to ensure that the global outlier candidates are, in fact, true global outliers.

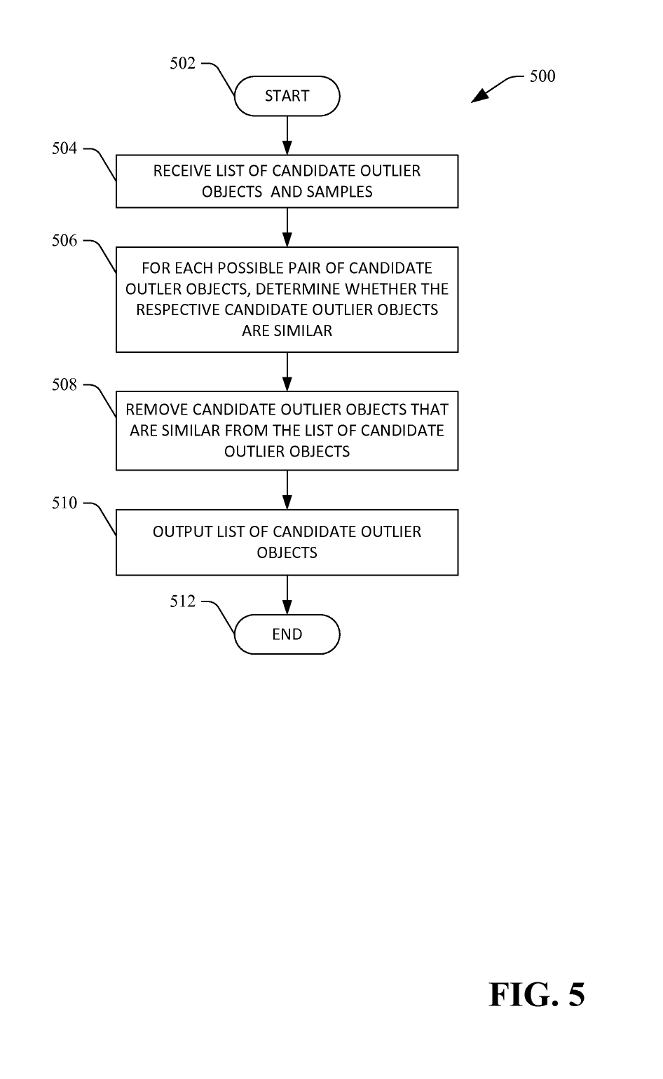

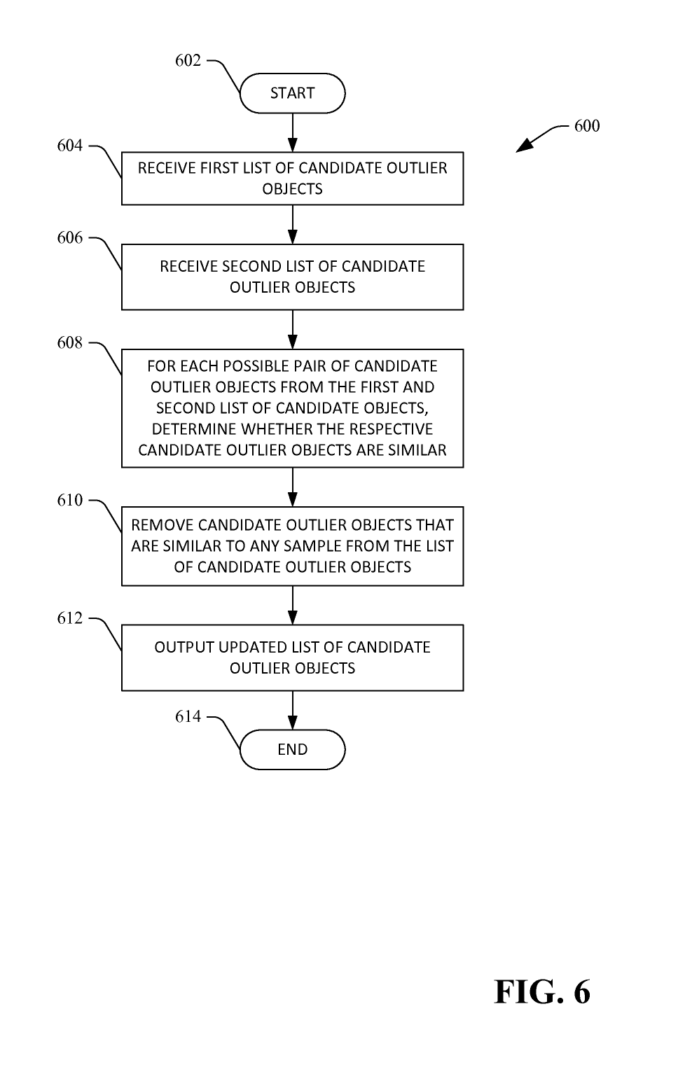

With reference now to FIGS. 5-6, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Now referring to FIG. 5, an exemplary methodology 500 that can be undertaken in connection with identifying outliers in a set of objects is illustrated. The methodology 500 starts at 502, and at 504, a list of candidate outlier objects is received. For example, the list of candidate outlier objects can be received from a computer-readable data repository.

At 506, for each possible pair of candidate outlier objects received at 504, a determination is made regarding whether or not the respective candidate outlier objects in the respective pair are similar to one another. At 508, any candidate outlier object that has been found to be similar to any other candidate outlier object in the list of candidate outlier objects received at 504 is removed from such list of candidate outlier objects.

At 510, the list of candidate outlier objects is output. As described above, the list can be output in the form of several key/value pairs, wherein a key of each of the key/value pairs is a unique task identifier. The methodology 500 completes at 512.

Now referring to FIG. 6, an exemplary methodology 600 that facilitates identifying outliers in a set of objects is illustrated. The methodology 600 starts at 602, and at 604 a first list of candidate outlier objects is received from a first computing node. As discussed above, each candidate outlier object in the first list of candidate outlier objects has been found to be sufficiently dissimilar from every other candidate object in the first list of first list of candidate outlier objects. Moreover, each object in the first list of candidate outlier objects has a same first unique task ID assigned thereto, wherein the first task ID can indicate a computing node and/or process that output the first list of candidate outlier objects.

At 606, a second list of candidate outlier objects is received from a second computing node in a distributed computing environment. Each candidate outlier object in the second list of candidate outlier objects is sufficiently dissimilar from every other candidate outlier object in the second list of candidate outlier objects. Furthermore, each candidate outlier object in the second list of candidate outlier objects has a second unique task ID assigned thereto, which indicates that the second list of candidate outlier objects was output by a process or a second process and/or second computing node.

At 608, at a third computing node in the distributed computing environment, for each possible pair of candidate outlier objects from the first list of candidate outlier objects and the second list of candidate outlier objects, a determination is made regarding whether the respective candidate outlier objects, in the respective pair of candidate outlier objects, are similar.

At 610, outlier in pairs of outlier objects subject to analysis at 608 that are found to be similar to one another are removed from consideration as being candidate outlier objects. Candidate outlier objects from either the first list of candidate outlier objects or the second list of candidate outlier objects that are found to be sufficiently dissimilar from every other outlier object in either the first list of candidate outlier objects or the second list of candidate outlier objects are identified as being updated candidate outlier objects.

At 612, a data packet is output that comprises an indication that at least one candidate outlier object has been identified as being sufficiently dissimilar from every other candidate outlier object in the first set or second list of candidate outlier objects. Furthermore, a task ID is included in such data packet. The methodology 600 completes at 614.

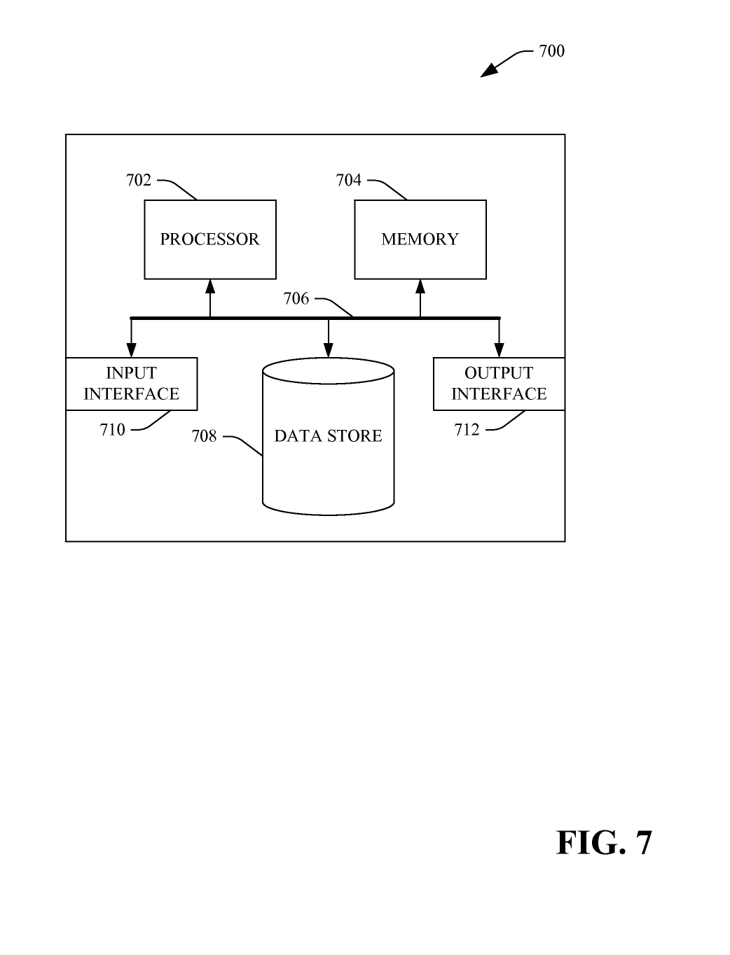

Now referring to FIG. 7, a high-level illustration of an exemplary computing device 700 that can be used in accordance with the systems and methodologies disclosed herein is illustrated. For instance, the computing device 700 may be used in a system that supports identifying outliers in a data set. The computing device 700 includes at least one processor 702 that executes instructions that are stored in a memory 704. The memory 704 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store computer-readable data objects, unique task IDs, local outlier candidates, global outlier candidates, etc.

The computing device 700 additionally includes a data store 708 that is accessible by the processor 702 by way of the system bus 706. The data store may be or include any suitable computer-readable storage, including a hard disk, memory, etc. The data store 708 may include executable instructions, computer-readable objects, task IDs, etc. The computing device 700 also includes an input interface 710 that allows external devices to communicate with the computing device 700. For instance, the input interface 710 may be used to receive instructions from an external computer device, a user, etc. The computing device 700 also includes an output interface 712 that interfaces the computing device 700 with one or more external devices. For example, the computing device 700 may display text, images, etc. by way of the output interface 712.

Additionally, while illustrated as a single system, it is to be understood that the computing device 700 may be a distributed system. Thus, for instance, several devices may be in communication by way of a network connection and may collectively perform tasks described as being performed by the computing device 700.

While the computing device 700 has been presented above as an exemplary operating environment in which features described herein may be implemented, it is to be understood that other environments are also contemplated. For example, hardware-only implementations are contemplated, wherein integrated circuits are configured to perform predefined tasks. Additionally, system-on-chip (SoC) and cluster-on-chip (CoC) implementations of the features described herein are also contemplated. Moreover, as discussed above, features described above are particularly well-suited for distributed computing environments, and such environments may include multiple computing devices (such as that shown in FIG. 7), multiple integrated circuits or other hardware functionality, SoC systems, CoC systems, and/or some combination thereof.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method configured for execution in a distributed computing environment that comprises a plurality of nodes that are in direct or indirect communication with one another, the method comprising:
receiving, from a first computing node in the distributed computing environment, a first set of local outlier candidates, each local outlier candidate in the first set of local outlier candidates identified as being sufficiently dissimilar from every other local outlier candidate in the first set of local outlier candidates, wherein each local outlier candidate in the first set of local outlier candidates has a first task identifier assigned thereto that indicates that a respective local outlier candidate in the first set of local outlier candidates was output by the first computing node;
receiving, from a second computing node in the distributed computing environment, a second set of local outlier candidates, each local outlier candidate in the second set of local outlier candidates identified as being sufficiently dissimilar from every other local outlier candidate in the second set of local outlier candidates, wherein each local outlier candidate in the second set of local outlier candidates has a second task identifier assigned thereto that indicates a respective local outlier candidate from the second set of local outlier candidates was output by the second computing node, wherein the first set of local outlier candidates and the second set of local outlier candidates are received at a third computing node based at least in part upon the first task identifier and the second task identifier;
at the third computing node, identifying, from the first set of local outlier candidates, at least one local outlier candidate that is sufficiently dissimilar from each local outlier candidate in the second set of local outlier candidates; and
outputting a data packet that comprises an indication that the at least one local outlier candidate has been identified as being sufficiently dissimilar from each local outlier candidate in the second set of local outlier candidates.

2. The method of claim 1, wherein the data packet that comprises the indication that the at least one local outlier candidate has been identified as being sufficiently dissimilar from each local outlier candidate in the second set of local outlier candidates comprises a third task identifier that indicates that the data packet has been output by the third computing node.

3. The method of claim 1, wherein the identifying, from the first set of outlier candidates, the at least one local outlier candidate that is sufficiently dissimilar from each local outlier candidate in the second set of local outlier candidates comprises determining that:
min(|x|,|y|)≦0.5×t×(|x|+|y|), where x=(x₁, . . . x_{D})^{T}, y=(y₁, . . . , y_{D})^{T},
where (x₁, . . . x_{D})^{T} is a feature vector for the at least one local outlier candidate x from the first set of local outlier candidates, (y₁, . . . y_{D})^{T} is a feature vector at a local outlier candidate y from the second set of local outlier candidates, |·| is a number of non-zero components of a feature vector, and t is a user-defined distance threshold.

4. The method of claim 1, wherein the identifying, from the first set of outlier candidates, the at least one local outlier candidate that is sufficiently dissimilar from each local outlier candidate in the second set of local outlier candidates comprises determining that:
Σᵢ₌₁^{k}δ(xᵢ,yᵢ)>0.5×t×(|x|+|y|), k=1, . . . , D, where
$$δ ( {x}_{i} , {y}_{i} ) = \{ \begin{matrix}1 , if {x}_{i} = {y}_{i} \\ 0 , otherwise ,\end{matrix}$$
where x is the at least one local outlier candidate from the first set of local outlier candidates, y is a local outlier candidate from the second set of local outlier candidates, and |·| is a number of non-zero components of a feature vector.

5. The method of claim 1 configured for execution in a map reduce framework.

6. The method of claim 1, wherein the first set of local outlier candidates and the second set of local outlier candidates are documents.

7. The method of claim 6, wherein the documents are web pages.

8. The method of claim 6, wherein the documents are micro-blog entries.

9. The method of claim 6, wherein the documents are messages generated in a web-based social networking application.

10. The method of claim 1, further comprising:
receiving, at a fourth computing node in the plurality of computing nodes, a data packet that comprises an indication that the at least one local outlier candidate has been identified as being sufficiently dissimilar from each local outlier candidate in the second set of local outlier candidates;
receiving, at the fourth computing node, another data packet that comprises another local outlier candidate; and
identifying that the at least one local outlier candidate and the another local outlier candidate are sufficiently dissimilar; and
outputting, from the fourth computing node, the at least one local outlier candidate and the another local outlier candidate to a fifth computing node in the plurality of computing nodes.

11. A system that facilitates identifying outliers in a set of objects, the system comprising:
a plurality of computing nodes that are directly or indirectly in communication with one another, the plurality of computing nodes executing a plurality of computer-executable components cooperatively through utilization of a distributed computing framework, the plurality of computer-executable components comprising:
a local outlier mapper component that receives a plurality of objects and, for each pair of objects in the plurality of objects, identifies whether a respective first object in a respective pair of objects is sufficiently dissimilar from a respective second object in the respective pair of objects and constructs a first list of local outlier candidates responsive to identifying whether the respective first object in the respective pair of objects is sufficiently dissimilar from the respective second object in the respective pair of objects, the first list of local outlier candidates comprising objects that are sufficiently dissimilar from every other object in the plurality of objects, and wherein the local mapper outlier component outputs the first list of local outlier candidates; and
a local outlier reducer component that receives the first list of local outlier candidates and a second list of local outlier candidates and generates pairs of outlier candidates, wherein each pair of outlier candidates comprises a respective outlier candidate from the first list of local outlier candidates and a respective outlier candidate from the second list of local outlier candidates, and wherein for each generated pair of outlier candidates, identifies whether the outlier candidates in the respective pair of outlier candidates are sufficiently dissimilar, and outputs an updated list of outlier candidates subsequent to identifying whether outlier candidates in each pair of outlier candidates are sufficiently dissimilar, wherein outlier candidates in the updated list of outlier candidates are sufficiently dissimilar from each outlier candidate in the first list of local outlier candidates and each outlier candidate in the second list of outlier candidates.

12. The system of claim 11, wherein several instances of the local outlier reducer component are executed on several respective computing nodes in the plurality of computing nodes, wherein a number of computing nodes in the several respective computing nodes is a factor of two.

13. The system of claim 11, wherein the local outlier mapper component, when outputting the first list of local outlier components, indicates that a particular instance of the local outlier mapper component outputted the first list of local outlier components.

14. The system of claim 13, wherein the local outlier reducer component, when receiving the first list of local outlier components and the second list of local outlier components, receives the first list and the second list based at least in part upon the particular instance of the local outlier mapper component indicated by the local outlier mapper component when outputting the first list of local outlier components.

15. The system of claim 14, wherein the local outlier reducer component, when outputting the updated list of outlier candidates, indicates that a particular instance of the local outlier reducer component output the list of outlier candidates.

16. The system of claim 15, wherein another instance of the local outlier reducer component receives the updated list of outlier candidates based at least in part upon the particular instance of the local outlier reducer component that output the list of outlier candidates.

17. The system of claim 11, wherein objects in the plurality of objects are documents.

18. The system of claim 17, wherein the documents are one of web pages, micro-blogging entries, or text generated by way of a web-based social networking application.

19. The system of claim 11, wherein the distributed computing framework is a map reduce framework.

20. A computer-readable medium comprising instructions that, when executed collectively by a plurality of computing nodes in a distributed computing environment, cause the plurality of computing nodes to perform acts, comprising:
receiving a first list of outlier candidate documents at a first computing node in the distributed computing environment, the first list of outlier candidate documents comprising documents that have been identified as being sufficiently dissimilar from one another and from every other document in a first set of documents;
receiving a second list of outlier candidate documents at the first computing node in the distributed computing environment, the second list of outlier candidate documents comprising documents that have been identified as being sufficiently dissimilar from one another and from every other document in a second set of documents, wherein the first list of outlier candidate documents is received from a second computing node in the distributed computing environment and the second list of outlier candidate documents is received from a third computing node in the distributed computing environment;
generating, from the first list of outlier candidate documents and the second list of outlier candidate documents, an updated list of outlier candidate documents, the updated list of outlier candidate documents comprising documents that are sufficiently dissimilar from every other document in the first list of outlier candidate documents and the second list of outlier candidate documents; and
outputting the updated list of outlier candidates to a fourth computing node together with a task identifier that uniquely identifies the updated list of outlier candidates from amongst other lists of outlier candidates.
